(19) United States
(12) Patent Application Publication
(10) Pub. No.: US 2012/0125913 A1
(43) Pub. Date: May 24, 2012

(54) APPARATUS FOR HEATING A PIPE

(75) Inventor: Bum Shik Song, Gyeonggi-do (KR)

(73) Assignee: In Sun CHOI, Hwaseong-si Gyeonggi-Do (KR)

(21) Appl. No.: 13/388,865

(22) PCT Filed: Jul. 27, 2010
(86) PCT No.: PCT/KR2010/004926

§ 371 Date: Feb. 3, 2012

(30) Foreign Application Priority Data
Aug. 5, 2009 (KR) 10-2009-0071904

(51) Int. Cl. H05B 3/02

(52) U.S. Cl. 219/546

(57) ABSTRACT

An apparatus for heating a pipe is disclosed. An apparatus for heating a pipe configured to heat a pipe line by covering the pipe line, which comprises: an inner sheet covering the pipe line in such a way that one surface thereof faces an outer surface of the pipe line; a heating wire distributed on the other surface of the inner sheet; an insulation pad stacked on the other surface of the inner sheet and configured to insulate heat emitted from the heating wire; and stitches configured to fix the heating wire to the inner sheet or the insulation pad, can simplify the configuration and manufacturing process of the apparatus for heating a pipe.

### TECHNICAL FIELD

The present invention relates to an apparatus for heating a pipe, more specifically to an apparatus for heating a pipe that heats a pipe line installed for supplying gas or liquid required for a semiconductor fabrication process, an LCD process or a chemical process.

### BACKGROUND ART

In a semiconductor fabrication process, an LCD (liquid crystal display) process, a chemical process, etc., various pipe lines are installed for supplying reaction gas or liquid. These processes require that the gas or liquid that moves along the pipe lines be maintained at a constant temperature.

If the gas or liquid, which is solidified due to a change in temperature, moves along the pipe line, there may be particles inside the pipe line if temperature changes. To prevent this, it is required that the gas or liquid moving along the pipe line is maintained at a constant temperature.

FIG. 1 illustrates an apparatus for heating a pipe in accordance with a prior art. The apparatus for heating a pipe in accordance with the prior art is produced by arranging a heating wire 40, such as a nichrome wire, between two sheets 38, 39 that are stacked onto each other to produce a heater mat 34 and then attaching the heater mat 34 to an inner surface of an insulation jacket 36, such as a polymer foam or silicon sponge rubber.

The heater mat 34 and the insulation jacket 36 are produced to correspond to the shape of a pipe P. Specifically, the heater mat 34 is produced to correspond to the shape of the pipe P by arranging and heating the two sheets 38, 39, in which the heating wire 40 is arranged, inside a mold. Moreover, the insulation jacket 36 is produced by arranging the heater mat 34 in a mold corresponding to the shape of the pipe P and then frothing a foam material.

The apparatus for heating a pipe in accordance with the prior art requires two sheets in order to produce the heater mat, making the configuration complicated, and makes the heating wires cross one another due to the movement of the heating wires in a manufacturing process, risking the possibility of short circuit during the use.

Moreover, since the heater mat is arranged in a mold and the foam material is frothed, the manufacturing process is complicated.

### DISCLOSURE

### Technical Problem

The present invention provides an apparatus for heating a wire, of which the configuration and the manufacturing process are simple.

### Technical Solution

An aspect of the present invention provides an apparatus for heating a pipe configured to heat a pipe line by covering the pipe line, which includes: an inner sheet covering the pipe line in such a way that one surface thereof faces an outer surface of the pipe line; a heating wire distributed on the other surface of the inner sheet; an insulation pad stacked on the other surface of the inner sheet and configured to insulate heat emitted from the heating wire; and stitches configured to fix the heating wire to the inner sheet or the insulation pad.

The heating wire can include a bundle of stainless steel fibers, in which case, a diameter of the stainless steel fiber can be between 8 μm and 14 μm.

The heating wire can also include an insulation coating covering the bundle of stainless steel fibers.

The apparatus for heating a pipe can also include a cover jacket configured to hold the insulation pad to the pipe by covering the insulation pad. Moreover, the apparatus for heating a pipe can also include a control unit configured to control a temperature of the heating wire by being electrically connected with the heating wire.

The inner sheet and the insulation pad can be attached to each other by an adhesive.

The insulation pad and the cover jacket can be attached to each other by an adhesive.

The inner sheet can be made of a heat-resistance material.

The inner sheet and the insulation pad can have shapes corresponding to a shape of the pipe line.

The sheet and the insulation pad can be sewed to be attached to each other.

The insulation pad and the cover jacket can be sewed to be attached to each other.

### Advantageous Effects

With the present invention, the configuration and the manufacturing process of the apparatus for heating a wire are simple.

### DESCRIPTION OF DRAWINGS

FIG. 1 illustrates an apparatus for heating a pipe in accordance with a prior art.

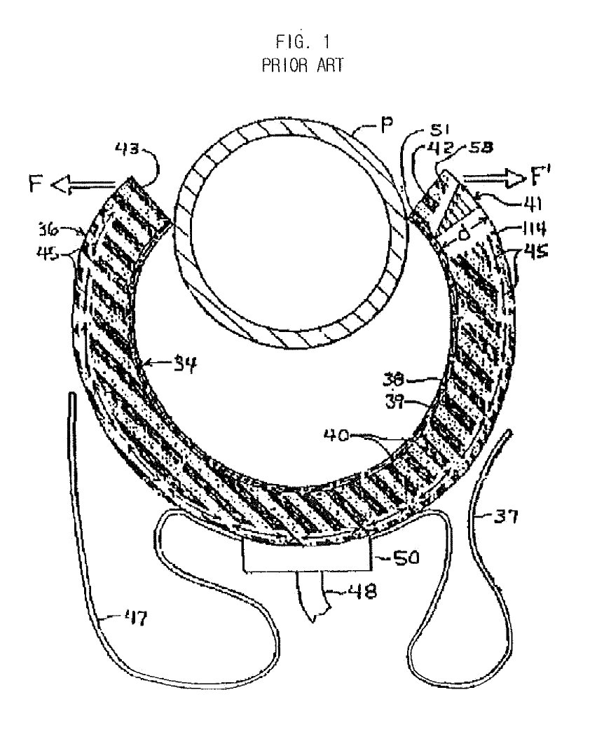

FIG. 2 is a perspective view of an apparatus for heating a pipe in accordance with an embodiment of the present invention.

FIG. 3 is a cross-sectional view of the apparatus for heating a pipe in accordance with an embodiment of the present invention.

FIG. 4 is a perspective view of an apparatus for heating a pipe in accordance with another embodiment of the present invention.

FIG. 5 illustrates how the apparatus for heating a pipe in accordance with another embodiment of the present invention is used.

<Description of Key Elements>

| | |
|---|---|
| 12: pipe line | 14: inner sheet |
| 16: heating wire | 18: insulation pad |
| 20: stitch | 22: cover jacket |
| 28: Velcro-type fastener | 30: control unit |

### MODE FOR INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of the present invention, when describing a certain technology is determined to evade the point of the present invention, the pertinent detailed description will be omitted.

Hereinafter, certain embodiment of an apparatus for heating a pipe in accordance with the present invention will be described in detail with reference to the accompanying drawings. Identical or corresponding elements will be given the same reference numerals, regardless of the figure number, and any redundant description ion of the identical or corresponding elements will not be repeated.

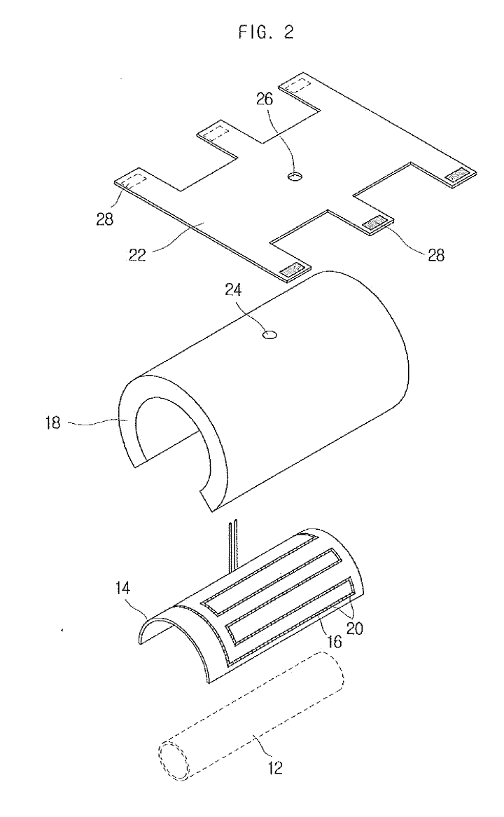

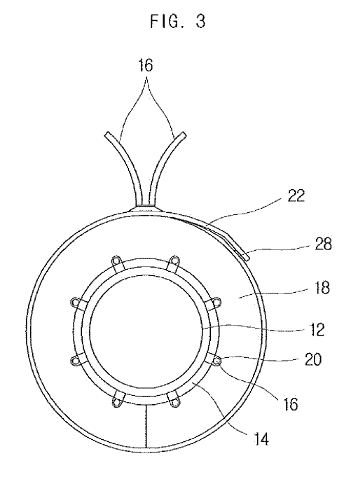

FIG. 2 is a perspective view of an apparatus for heating a pipe in accordance with an embodiment of the present invention, and FIG. 3 is a cross-sectional view of the apparatus for heating a pipe in accordance with an embodiment of the present invention. Illustrated in FIGS. 2 and 3 are a pipe line 12, an inner sheet 14, a heating wire 16, an insulation pad 18, stitches 20, a cover jacket 22, through-holes 24, 26 and Velcro-type fasteners 28.

The apparatus for heating a pipe in accordance with the present embodiment, which covers and heats the pipe line 12, includes the inner sheet 14 covering the pipe line 12 in such a way that one surface thereof can face an outer surface of the pipe line 12, the heating wire 16 distributed on the other surface of the inner sheet 14, the insulation pad 18 stacked on the other surface of the inner sheet 14 and insulating the heat emitted from the heating wire 16, and the stitches 20 fixing the heating wire 16 to the inner sheet 14 or the insulation pad 18, thereby simplifying the structure and manufacturing process of the apparatus for heating a pipe.

The pipe line 12 is where fluid such as gas or liquid is transported in a semiconductor fabrication process, an LCD process or a chemical process, and the fluid moving in the pipe line 12 needs to maintain a constant temperature.

The inner sheet 14 covers the pipe line 12 in such a way that one surface thereof faces the outer surface of the pipe line 12 and must not be deformed by the high-temperature fluid that flows in the pipe line 12 or by the heat emitted from the heating wire 16, which is described below.

The inner sheet 14 can be made of a heat-resistance material, for example, glass fiber, metal fiber, aramid fiber, heat-resistant composite fiber, heat-resistant textiles including basalt fiber spun from basalt, heat-resistant sheets such as glass fiber reinforced sheets, and heat-resistant silicon.

The inner sheet 14 is formed in accordance with the shape of the pipe line 12 so that the pipe line 12 to be heated can be covered.

It is possible to further include a protective layer (not shown) on one surface of the inner sheet 14 lest the inner sheet 14 should be damaged by friction or heat if the inner sheet 14 is in direct contact with the pipe line 12. The protective layer can be made of a heat-resistance material, like the inner sheet 14.

The heating wire is distributed on the other surface of the inner sheet 14 in accordance with the shape of the pipe line 12 so that the heat emitted from the heating wire 16 can be distributed evenly to the pipe line 12 to heat the pipe line 12.

Used for the heating wire 16 can be resistance wires, such as a nickel chrome wire, a nickel chrome steel wire, nickel copper, nickel steel, etc., which are generally known to have big electrical resistance.

Meanwhile, a resistance wire made of a material including stainless steel can be used for the heating wire 16. The resistance wire having the material including stainless steel is more flexible than the nichrome wire and thus is not easily disconnected despite repeated bending, thereby preventing problems that may be caused by disconnection.

Moreover, a bundle of stainless steel fibers can be used for the heating wire 16. The diameter of a stainless steel fiber can be between 8 μm and 14 μm, the stainless steel fibers having said diameter are bundled together to be used for the heating wire 16. By using the fiber bundle as the heating wire 16, the heating wire 16 becomes flexible and thus can be used semi-permanently without disconnection despite the repeated bending.

The stainless steel fiber bundle can be covered with an insulation coating in order for the stainless steel fiber bundle to maintain its linear form and to prevent disconnection from adjacent heating wires. Used for the insulation coating can be an insulating material such as Teflon.

In order to prevent the heating wire 16 from being moved while the apparatus for heating a wire is used or manufactured, the heating wire 16 needs to be fixed to the inner sheet 14 or the insulation pad 18. For this, in the present invention, the heating wire 16 is stitched to the inner sheet 14 or the insulation pad 18. Suggested in the present embodiment is a form in which the heating wire 16 is stitched to the inner sheet 14 with threads. The threads used for stitching in order to fix the heating wire 16 can be made of heat-resistant fiber.

The insulation pad 18 insulates the heat so that the heat emitted from the heating wire 16 is not leaked to the outside. Used for the insulation pad 18 can be textiles weaved with insulation fibers such as Kevlar fiber, PBO (Polybenzoxazole) fiber, glass fiber, etc. These kinds of insulation fibers can be tailored according to the shape of the pipe line 12 to be used as the insulation pad 18.

It is also possible to froth silicon, polymer, epoxy, polyurethane, etc. in accordance with the shape of the pipe line 12 for use as the insulation pad 18.

The heating line 16 is stitched and fixed to the inner sheet 14 or the insulation pad 18. It is possible to fix the heating wire 16 to the inner sheet 14 or the insulation pad 18 by manually stitching the heating wire 16 to the inner sheet 14 or the insulation pad 18 or by using a sewing machine to sew the heating wire 16 to the inner sheet 14 or the insulation pad 18.

Suggested in the present embodiment is a form in which the heating wire 16 is stitched and fixed to the inner sheet 14. The stitches 20 formed by stitching cross the heating wire 16 to fix the heating wire 16 to the inner sheet 14.

The stitches 20 are formed at regular intervals in a lengthwise direction of the heating wire 16 distributed on the other surface of the inner sheet 14 and prevent the heating wire 16 from being moved during the use or manufacture of the apparatus for heating a wire. It is also possible that the stitches 20 are closely formed in an over-lock fashion so as to cover the heating wire 16 to fix the heating wire 16 to the inner sheet 14 or the insulation pad 18.

The cover jacket 22 covers the insulation pad 18 to get the insulation pad 18 held with the pipe line 12. By arranging a snap button or the Velcro-type fasteners 28 at end portions of the cover jacket 22, the insulation pad 18 can be held with the pipe line 12.

Suggested in the present embodiment is a form in which the Velcro-type fasteners 28 are attached to end portions of strips extended from both ends of the cover jacket 22 and the insulation pad 18 is fixed to the pipe line 12 by affixing the Velcro-type fasteners 28 to one another.

A control unit can be electrically connected to end portions of the heating wire 16 distributed on the inner sheet 14 to control the temperature of the heating wire 16. By forming the through-holes 24, 26 in the insulation pad 18 and the cover jacket 22, respectively, the end portions of the heating wire 16 can be exposed to the outside through the through-holes 24, 26, and the temperature of the heating wire 16 can be controlled by electrically connecting the control unit to the exposed heating wire 16.

It is also possible that a temperature sensor is added in order to measure the temperature of the pipe line. The temperature sensor is installed on a surface of the inner sheet 14 to allow the control unit to read the temperature of the pipe line 12.

Although it is described in the present embodiment that one heating wire 16 is distributed on the inner sheet 14, it is also possible that multiple heating wires are distributed on the other surface of the inner sheet 14 if the area of the pipe line 12 is wide or the shape of the pipe line 12 complicated. In such a case, it is necessary that the multiple heating wires are maintained at a particular temperature, and this particular temperature can be maintained among the multiple heating wires by use of the control unit.

The apparatus for heating a wire in accordance with the present embodiment can be installed on the pipe line 12 as follows. Firstly, the inner sheet 14 is wrapped around the pipe line 12 in such a way that one surface of the inner sheet 14, to which the heating wire 16 is fixed by the stitches 20, faces the outer surface of the pipe line 12. Then, the insulation pad 18 is covered over the inner sheet 14, and the insulation pad 18 is held to the pipe line 12 with the cover jacket 22 to complete the installation of the apparatus for heating a pipe on the pipe line 12. As the inner sheet 14, the insulation pad 18 and the cover jacket 22 are separately installed, it is easy to detect and replace a part if the part is damaged during the use.

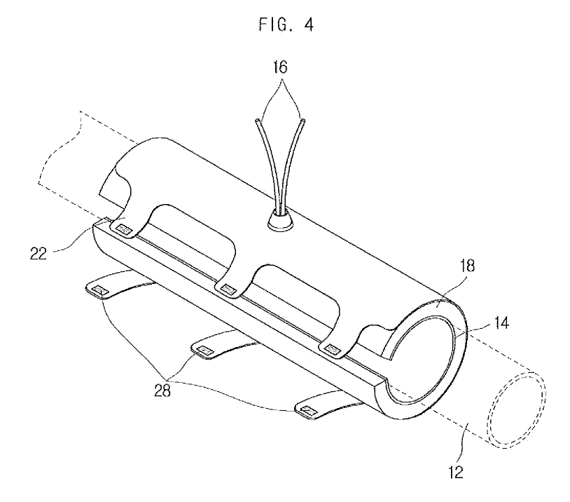

FIG. 4 is a perspective view of an apparatus for heating a pipe in accordance with another embodiment of the present invention. Illustrated in FIG. 4 are a pipe line 12, an inner sheet 14, a heating wire 16, an insulation pad 18, a cover jacket 22 and Velcro-type fasteners 28.

The present embodiment takes a form in which the apparatus for heating a pipe is partially or entirely integrated into one body for easier installation of the apparatus for heating a pipe on a complex pipe line 12. For this, it is possible: to coat adhesive in between the inner sheet 14, to which the heating wire 16 is stitched and fixed, and the insulation pad 18 to integrate the inner sheet 14 and the insulation pad 18 into one body; to coat adhesive in between the insulation pad 18 and the cover jacket 22 to integrate the insulation pad 18 and the cover jacket 22 into one body; and to coat adhesive in between the inner sheet 14, to which the heating wire 16 is stitched and fixed, the insulation pad 18 and the cover jacket 22 to integrate the inner sheet 14, the insulation pad 18 and the cover jacket 22 into one body.

Meanwhile, in case the insulation pad 18 or the cover jacket 22 is made of a material that can be stitched, the inner sheet 14 and the insulation pad 18 can be stitched together to be affixed to each other, and the insulation pad 18 and the cover jacket 22 can be also stitched together to be affixed to each other.

Suggested in the present embodiment is a form in which the inner sheet 14, the insulation pad 18 and the cover jacket 22 are integrated into one body by coating adhesive in between the inner sheet 14, to which the heating wire 16 is stitched and fixed, the insulation pad 18 and the cover jacket 22.

In case the pipe line 12 is very long or complexly shaped, it is necessary to heat the pipe line 12 by dividing the pipe line 12 into multiple portions, and it is possible to manufacture in advance a plurality of apparatuses for heating a pipe that correspond to the shapes of the divided pipe line 12 and install the pre-manufactured apparatus for heating a pipe directly on the pipe line 12, thereby reducing the time required for installation.

The heating wires 16 of the plurality of apparatuses for heating a pipe installed on the pipe line 12 can be electrically connected to one another for control of the temperature of the heating wires 16 through a single control unit.

Other elements are the same as or similar to the above-described elements, and thus the description thereof will be omitted.

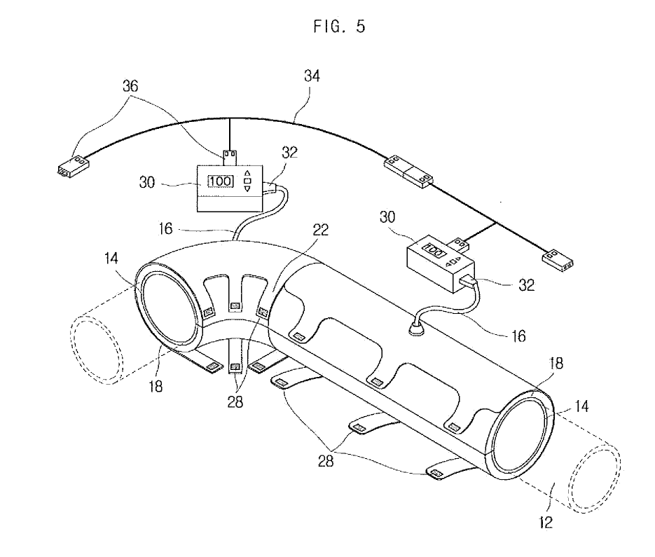

FIG. 5 illustrates how the apparatus for heating a pipe in accordance with another embodiment of the present invention is used. Illustrated in FIG. 5 are the pipe line 12, the inner sheet 14, the heating wire 16, the insulation pad 18, the cover jacket 22, the Velcro-type fasteners 28, a control unit 30, a connection jack 32, and a power cable 34.

A pipe line for a semiconductor fabrication process, an LCD manufacturing process or a chemical process is formed by connecting various types of pipes, such as a linear type, an elbow type, a T type, etc. In order to heat these various types of pipes, it is necessary to have apparatuses for heating a pipe that respectively correspond to these shapes.

In FIG. 5, it is illustrated that the apparatuses for heating a pipe in accordance with the present embodiment are installed on the pipe line 12, in which an elbow-shaped pipe and a linear pipe are connected.

The apparatus for heating a pipe corresponding to the elbow-shaped pipe is manufactured by tailoring a heat-resistant textile to prepare the inner sheet 14 so as to cover the elbow-shaped pipe, distributing the heating wire 16 on the other surface of the inner sheet 14, stitching and fixing the heating wire 16 to the other surface of the inner sheet 14, and then preparing the insulation pad 18 that is formed to correspond to the elbow-shaped pipe.

In case the insulation pad 18 is made of textiles, the insulation can be prepared by properly cutting and sewing the textiles to correspond to the shape of the pipe line 12. If the insulation pad 18 is made of silicon, polymer, epoxy, polyurethane, etc., the insulation pad 18 can be prepared by frothing silicon, polymer, epoxy, polyurethane, etc. in a mold that corresponds to the shape of the elbow shape.

The apparatus for heating a pipe in accordance with the present embodiment has a form in which the inner sheet 14, the insulation pad 18 and the cover jacket 22 are integrated into one body by coating adhesive in between the inner sheet 4, to which the heating wire 16 is stitched and fixed, the insulation pad 18 and the cover jacket 22.

The apparatus for heating the linear pipe and the apparatus for heating the elbow-shaped pipe are adjacently installed on the pipe line and held to the pipe line by use of the Velcro-type fasteners 28. It is also possible that an area where the apparatuses for heating the pipes are adjacent can be taped lest heat should be released through the area where the apparatuses for heating the pipes are adjacent.

The connection jack 32 for making a connection with the control unit 30 can be arranged at an end portion of the heating wire 16 of the apparatus for heating a pipe, and the control unit 30 and the heating wire 16 can be electrically connected to each other by inserting the connection jack 32 into the control unit 30.

Arranged at one end portion of the power cable 34 for supplying electric power is a connector 36 for connecting with the control unit 30. The other end portion of the power cable 34 is divided into two branches, and each of end portions of the branched cable is provided with the connector 36 for connecting with an adjacent apparatus for heating a pipe.

One end portion of the power cable 34 is connected with the control unit 30 by the connector 36, and the other end portion of the power cable 34 is connected with the power cable 34 of the adjacent apparatus for heating a pipe by the connector 36 of the branched cable.

If a plurality of apparatuses for heating a pipe are installed, the power cable 34 for every apparatus for heating a pipe is connected with one another, and then the branched cable of the outermost apparatus for heating a pipe is connected to a power supply unit in order to supply the power to the apparatuses for heating a pipe.

The control unit 30 can be later connected by the connection jack, as described above, or can be integrated into one body at an end portion of the heating wire 16.

Although the present embodiment has a control unit 30 for each apparatus for heating a pipe in order to control the temperature, it is also possible that every apparatus for heating a pipe is connected in parallel and the temperature is controlled by a single control unit.

Moreover, although the apparatuses for heating an elbow-shaped pipe and a linear pipe are described, it shall be appreciated that the apparatus for heating a pipe in accordance with the present invention can be applied to various types of pipes, such as linear-types and T-shaped types, as well as various types of components constituting a pipe line, for example, a valve that opens and closes a fluid.

Although certain embodiments of the present invention have been described, it shall be appreciated that a variety of modifications and permutations of the present invention are possible by a person skilled in the art to which the present invention pertains without departing from the technical ideas and scope of the present invention defined by the claims appended below.

1. An apparatus for heating a pipe configured to heat a pipe line by covering the pipe line, comprising:
an inner sheet covering the pipe line in such a way that one surface thereof faces an outer surface of the pipe line;
a heating wire distributed on the other surface of the inner sheet;
an insulation pad stacked on the other surface of the inner sheet and configured to insulate heat emitted from the heating wire; and
stitches configured to fix the heating wire to the inner sheet or the insulation pad.

2. The apparatus for heating a pipe of claim 1, wherein the heating wire comprises a bundle of stainless steel fibers.

3. The apparatus for heating a pipe of claim 2, wherein a diameter of the stainless steel fiber is between 8 μm and 14 μm.

4. The apparatus for heating a pipe of claim 2, wherein the heating wire further comprises an insulation coating covering the bundle of stainless steel fibers.

5. The apparatus for heating a pipe of claim 1, further comprising a cover jacket configured to hold the insulation pad to the pipe by covering the insulation pad.

6. The apparatus for heating a pipe of claim 5, wherein the inner sheet and the insulation pad are attached to each other by an adhesive.

7. The apparatus for heating a pipe of claim 5, wherein the insulation pad and the cover jacket are attached to each other by an adhesive.

8. The apparatus for heating a pipe of claim 5, wherein the inner sheet is made of a heat-resistance material.

9. The apparatus for heating a pipe of claim 5, further comprising a control unit configured to control a temperature of the heating wire by being electrically connected with the heating wire.

10. The apparatus for heating a pipe of claim 5, wherein the inner sheet and the insulation pad have shapes corresponding to a shape of the pipe line.

11. The apparatus for heating a pipe of claim 5, wherein the inner sheet and the insulation pad are sewed to be attached to each other.

12. The apparatus for heating a pipe of claim 5, wherein the insulation pad and the cover jacket are sewed to be attached to each other.

13. The apparatus for heating a pipe of claim 2, further comprising a cover jacket configured to hold the insulation pad to the pipe by covering the insulation pad.

14. The apparatus for heating a pipe of claim 3, further comprising a cover jacket configured to hold the insulation pad to the pipe by covering the insulation pad.

15. The apparatus for heating a pipe of claim 4, further comprising a cover jacket configured to hold the insulation pad to the pipe by covering the insulation pad.

16. The apparatus for heating a pipe of claim 13, further comprising a control unit configured to control a temperature of the heating wire by being electrically connected with the heating wire.

17. The apparatus for heating a pipe of claim 14, further comprising a control unit configured to control a temperature of the heating wire by being electrically connected with the heating wire.

18. The apparatus for heating a pipe of claim 15, further comprising a control unit configured to control a temperature of the heating wire by being electrically connected with the heating wire.
